(19) United States
(12) Patent Application Publication
(10) Pub. No.: US 2015/0120607 A1
(43) Pub. Date: Apr. 30, 2015

(54) SYSTEM AND METHOD FOR CUSTOMER EVENT EMAIL CONSOLIDATION AND DELIVERY

(71) Applicant: Vonage Network LLC, Holmdel, NJ (US)

(72) Inventors: Murali Ramsunder, Springfield, NJ (US); John Scalice, East Windsor, NJ (US); Dinesh Sausan, New Delhi (IN); Penelope Braun, Brick, NJ (US); Sathyarajan Neethirajan, Chennai (IN)

(73) Assignee: Vonage Network LLC, Holmdel, NJ (US)

(21) Appl. No.: 14/062,146

(22) Filed: Oct. 24, 2013

(51) Int. Cl. G06Q 10/10

(52) U.S. Cl. CPC G06Q 10/10
USPC 705/344

(57) ABSTRACT

A method and apparatus for reporting information from separate customer event records in a consolidated message are provided herein. In some embodiments, a method for reporting information from separate customer event records in a consolidated message may include associating each of a plurality of event records with at least one rule; assigning the plurality of event records into at least one group based on an account identifier of a customer associated with each event record; and for each group of event records, creating at least one consolidated message to be sent to the customer including information associated with at least some of the event records.

### BACKGROUND

1. Field

Embodiments of the present invention generally relate to systems and methods for efficiently handling customer event data records, and more specifically for grouping separate customer event data records into a consolidated message.

2. Description of the Related Art

Customers of various services typically have the ability to manage their accounts online. For example, a telephony service customer may be able to access a website to add a line, pay bills, update addresses, perform line transfers, purchase additional lines, change emergency contact information (e.g., 911 information), and so on. When a customer updates components of their account online, an email may be sent to the customer confirming the change.

A customer may change more than one component during a login session, but will receive an email for each new/updated/changed component. In addition, a customer may make frequent changes/updates triggering an email for each change/update. If a customer receives too many email messages from a service provider, the customer may become irritated, and may begin to ignore all messages from the service provider.

Accordingly, there exists a need in the art to reduce the amount of emails to be sent to the customer while effectively communicating important information to the customer.

### SUMMARY

A method and apparatus for reporting information from separate customer event records in a consolidated message are provided herein. In some embodiments, a method for reporting information from separate customer event records in a consolidated message may include associating each of a plurality of event records with at least one rule; assigning the plurality of event records into at least one group based on an account identifier of a customer associated with each event record; and for each group of event records, creating at least one consolidated message to be sent to the customer including information associated with at least some of the event records.

In some embodiments, a system for including separate customer event records in a consolidated message may include a tagging engine configured to tag event records with one or more matching rules and insert the tagged event record into a tagged email queue, a poller configured to group the event records in the tagged email queue based on an account identifier of a customer associated with each event record, a rules engine configured to determine an event record status to assign to each event record based on a highest priority rule determined for each event record, a consolidation engine configured to consolidate the tagged event records with a same highest priority rule into a consolidated email template, and a send engine configured to send the consolidated email template to an email delivery system.

In some embodiments, an apparatus for including separate customer event records in a consolidated message may include at least one processor, at least one input device, and at least one storage device storing processor-executable instructions which, when executed by the at least one processor, performs a method. The method performed may include associating each of a plurality of event records with at least one rule; assigning the plurality of event records into at least one group based on an account identifier of a customer associated with each event record; and for each group of event records, creating at least one consolidated message to be sent to the customer including information associated with at least some of the event records.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a system for grouping separate customer event data records into a consolidated message, in accordance with embodiments consistent with the present application;

FIGS. 2A and 2B depict a flowchart for grouping separate customer event data records into a consolidated message, according to one or more embodiments of the invention; and

FIG. 3 is a detailed block diagram of a computer system, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to a scalable, secure customer account management system that organizes the emails generated from various backend systems and has them flow through a centralized event notification system by adapting a template based approach. Embodiments of the present invention improve the customer care experience for customers who frequently make changes to their service accounts, for example by adding a telephone line, paying bills, updating their addresses, performing line transfers (e.g., transferring a phone number from existing provider to new provider—also referred to as Local Number Porting (LNP)), purchasing additional lines, changing emergency contact information (e.g., 911 information), and the like. Each action by the customer may produce an associated “back-office processing event” (event).

Specifically, when a customer performs an action related to their account (e.g., online, via a customer service representative, via an automated call, and the like), an event record is created in the event notification system. The event is given an ID associated with the customer. In some exemplary embodiments of the present invention, instead of the event triggering an email to the customer, the event record is cached in an email queue for possible further processing. For example, each event may be analyzed and tagged (i.e., associated) with a rule. Generally, a rule represents certain actions/processing that may apply to the event based on the type of event. For example, event records created when a customer updates their address information may be tagged with a rule that instructs the system to hold the event record for a certain amount of time before reporting it to the customer via email. Events that are to be reported to the customer may then be consolidated into a single email based on the type of rule the events were tagged with. The consolidated email is delivered to the customer.

If an event record is not tagged with a rule (e.g. the event does not correspond to any of the rules in the event notification system) the email will be sent directly to the customer without being consolidated via an email template. Thus, in embodiments consistent with the present application, the inventive methods and systems produce a single “consolidated” email from multiple sets of events generated by customer account activity.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

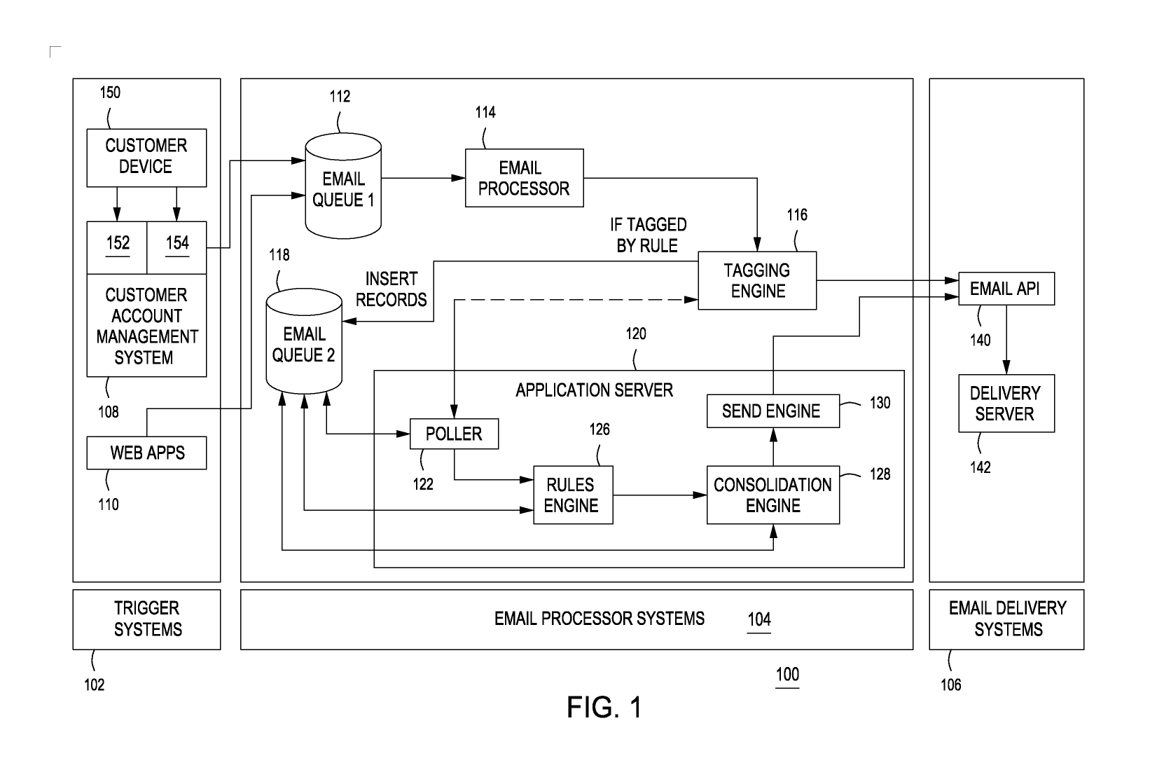

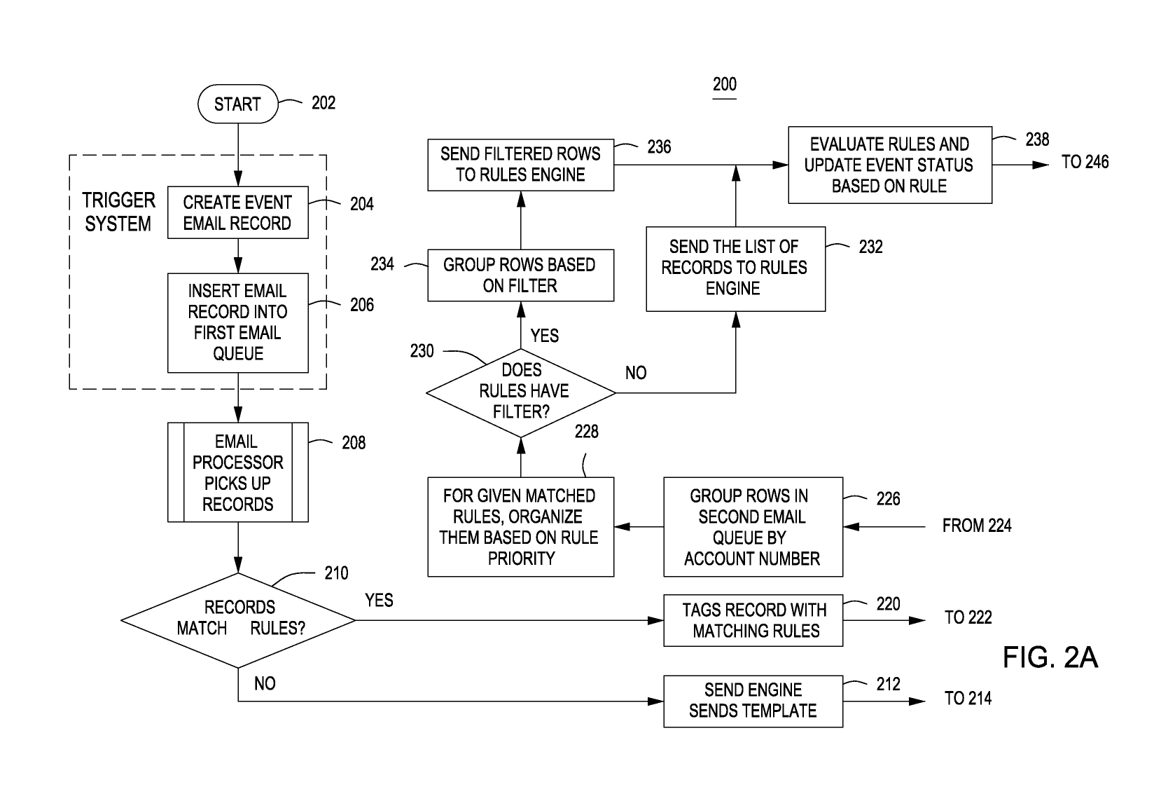

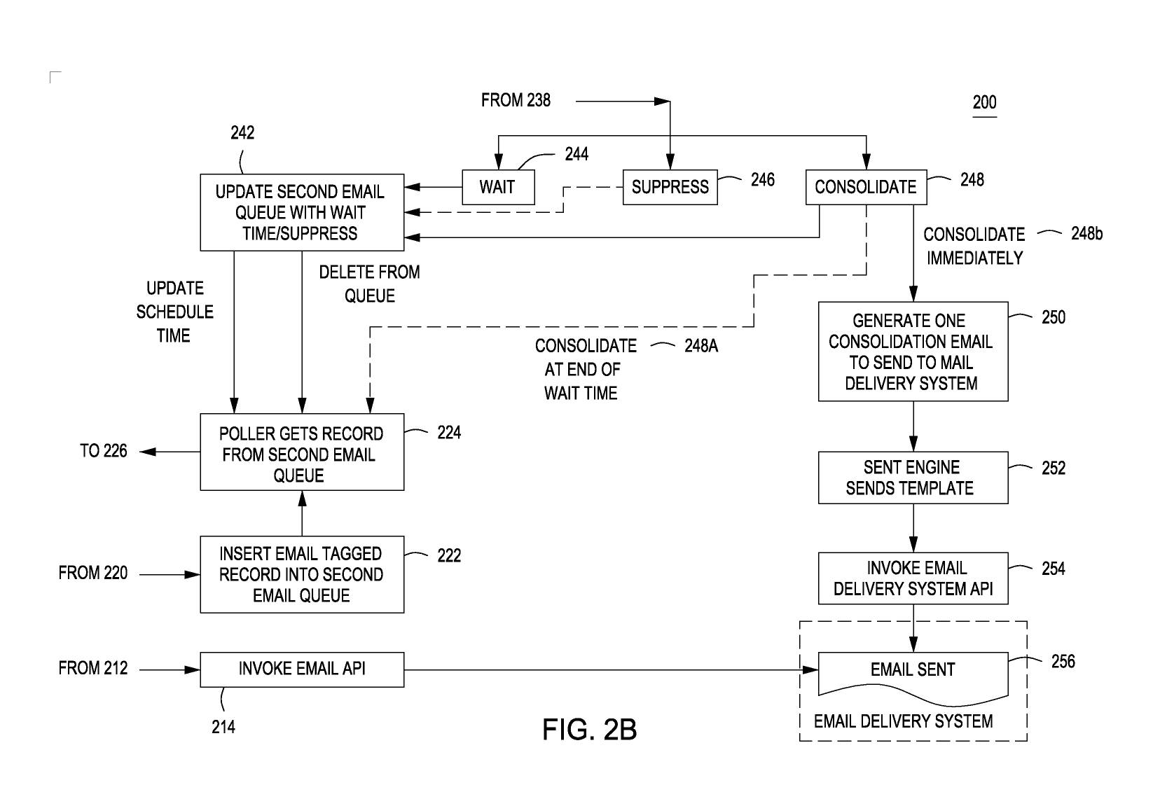

FIG. 1 depicts a block diagram of an event notification system 100 for grouping separate customer event data records into consolidated emails in accordance with embodiments consistent with the present application. The architecture depicted in FIG. 1 accommodates “rule-based” and “priority-based” approaches for processing event records and associated emails. The event notification system 100 includes trigger systems 102, email processor system 104, and email delivery systems 106. FIG. 2 depicts a flowchart of a method 200 for grouping separate customer event data records into a consolidated message as would be performed by event notification system 100, according to one or more embodiments of the invention. In method 200, steps 204 and 206 may be performed by trigger systems 102, steps 208 through 254 may be performed by email processor system 104, and step 256 may be performed by email delivery system 106.

The method 200 begins at 202 and proceeds to 204 where an event record is created based on changes to a customer's account information. For example, the change to the customer's account that triggers the creation of the event record may include at least one of adding a telephone line, paying a bill, updating an address of the customer, performing transfers, purchasing additional lines, or changing emergency contact information. These event records are created by trigger systems 102 and are inserted into one or more email queues 112 in the email processor system 104. The trigger systems 102 may include a customer account management system 108 which creates individual event records for each change to a customer's account made by the customer or by a customer service representative on behalf of the customer. In some embodiments, customer account management system 108 may include an online web interface 152 for customers to access via a customer device 150 (e.g., via a computer or telephone) to make changes to their account themselves, and/or may include an automated phone system 154 for making changes (e.g., through an IVR system). The customer account management system 108 may facilitate customer account actions such as, for example, adding a phone line, paying bills, updating their addresses, performing transfers, purchasing additional lines, changing emergency contact information (e.g., 911 information), and the like. A web/mobile app 110 used by the customer, or a representative on behalf of the customer, may also create individual event records (also referred to as email records herein).

At 206, the event record is inserted into a first email queue (e.g., 112). In some embodiments, the customer account management system 108 and/or the web/mobile apps 110 creates event records to be inserted in a first email queue 112 on the email processor system 104. The first email queue 112 holds an individual notification email for each account event that a customer needs to be notified about.

At 208, email processor 114 may be used to extract event records from the email queue 112 and send them to tagging engine 116 to be analyzed.

At 210, the tagging engine 116 will determine if any of the event records matched one or more rules. In some embodiments, the rules used by tagging engine 116 may be predetermined and created by a service provider for processing and emailing customer account event records.

If, at 210, any of the event records do not match any rules, the method proceeds to 212 where the send engine 130 sends the template to an email delivery system. More specifically, in some embodiments, if an event record does not match any rule, an email API 140 associated with email delivery system 106 may be directly invoked at 214 to deliver the email to the customer via email delivery server 142 at step 256.

However, if at step 210 an event record matches one or more rules, the tagging engine 116 will tag, or otherwise associated, the event record with all matching rules at 220. Tagged records with be inserted into a second email queue 118 at 222. The event record will include a field associating it with every rule that it matches. The second email queue 118 has access to additional information like Account Number (i.e., the customer's account number in the corresponding service provider system), Rules Applied, etc., to enable consolidation of the event records. In some embodiments, only tagged records are inserted into the second email queue 118 for further processing. Although described herein as separate email queues, in some embodiments, the first email queue 112 and the second email queue 118 may be physically or logically implemented as a single queue that receives updates to the event records.

Non-limiting examples of rules that a service provider may create may include those shown in Table 1:

TABLE 1

| Rule | | | |
|---|---|---|---|
| ID | Event Type | Rule Action | Wait Time |
| R1 | Account Change Confirmation; | Consolidate | 0 minutes |
| | New Subscriber event | Immediately | |
| R2 | 911 Address Received; 911 | Consolidate at | 40 minutes |
| | Address Verified | end of wait time | |
| R3 | Task Manager Actions (such as, | Wait | 50 minutes |
| | for example, back-office billing | | |
| | events such as payment | | |
| | received, payment method | | |
| | changed, and the like) | | |
| R4 | Order Confirmation, Ship | Consolidate at | 30 minutes |
| | Confirmation | end of wait time | |
| R5 | Account Security Event | Consolidate at | 30 minutes |
| | | end of wait time | |
| R6 | Customer Login | Suppress | N/A |

In Table 1 above, each rule is associated with certain types of events (e.g., account change confirmation, new subscriber event, and the like). A rule action and a wait time, if applicable, are associated with each rule. As used herein, “Consolidate” refers to the consolidation of event records into a single notification email to be sent to the customer. As shown in Table 1, some rules may instruct that an event record be consolidated immediately, while other rules may instruct that an event record may be consolidated after a predetermined wait time. In some embodiments, event records tagged with a rule that includes a “Suppress” event action are not sent to the customer as described below in further detail. If the event record includes a “Wait” or “Delay” action, then the event record will be updated in the second email queue 118 with an appropriate wait time defined by the applicable rule for further processing after the specified time.

At 224, the poller 122 will retrieve the records from the second email queue 118. The poller 122 may poll the second email queue 118 at a fixed, predetermined frequency. In some embodiments, the fixed, predetermined frequency may be about 2 seconds to about 30 minutes. In addition to, or in lieu of, actively retrieving records from the second email queue 118, the poller 122 may include event listeners that can be notified of an event added to queue in some embodiments. The event listeners would be notified, for example, via push notification initiated by the second email queue 118 of an event added to queue. In some embodiments, the poller 118 may retrieve, or otherwise be notified of, all records from the second email queue, while in other embodiments the poller 118 may retrieve, or otherwise be notified of, a fixed number of records. The records obtained may then be assigned to one or more groups by an account number (or according to some other predetermined criteria) of the customer at 226. The poller 118 may process each of the event records for a specific account number in parallel (e.g., a multi-threaded process that launches child threads to process each event record in the group).

In some embodiments, as shown at 228, the event records will be organized based the rule action to be applied to the event record. For example, in some embodiments, the highest priority rule based on the rule action for each event record will be determined. Specifically, each rule may have a priority associated with it. In some embodiments, the priority of a rule is based on the event information covered by the rule, the rule action, and time period that the event record tagged with the rule should be sent. For example, a first rule (e.g., rule R1 in Table 1 above) may require that event actions created for changes to a user's account should be consolidated with other event records scheduled to be reported to the customer and sent immediately. Meanwhile, a second rule (e.g., rule R5) may require that event records be consolidated and sent at the end of a wait time (e.g., 30 minutes) before sending. Thus, the first rule may be deemed to have a higher priority than the second rule because the time delay for consolidation is smaller. In other embodiments, other factors may be used to determine the priority of each rule. For each group of records grouped by account number, the poller 122 will analyze the records in the group to determine the highest priority rule (e.g., shortest wait time) for each event to determine which rule will be used to update the event status of the event.

In some embodiments, the method 200 may optionally proceed to step 230, where it is determined whether additional filters should be applied to the rules. If there are no additional filters to be applied to the rules, the list of records is sent to the rules engine at 232. If at 230 it is determined that the rules do have additional filters to be applied, then the event records are grouped based on the additional filters at 234 and subsequently sent to the rules engine at 236. In some embodiments, additional filters may include grouping rows of event records by event type for example.

At 238, the list of event records identified by the poller 122 may then be processed by a rules engine 126. The rules engine 126 will determine how the event record is to be processed using the rules the event record was tagged with. Specifically, the rules engine 126 evaluates the rules for each of the event records it is sent by poller 122 and updates the event status for each event record based on the rule action for each event record.

The method proceeds to one of 244, 246, or 248 based on the event status value. If the event status was updated to “wait” status at 244, then the event record will be updated in the second email queue with an appropriate wait time defined by the applicable rule. If the event status is updated to a “suppressed” status at 246, then the event record may be deleted from the second email queue. If the event status was updated to a “consolidate” status at 248, then the event record may either be consolidated immediately (i.e., 248b) or the event record will be consolidated at the end of a wait time defined by the applicable rule (i.e., 248a). In some embodiments, event records that are to be consolidated immediately, or after a wait time has expired, may be consolidated and sent to the customer once all records in the list of event records for an account number are evaluated by the rules engine 126. Specifically, as described above, the poller 118 may process each of the event records for a specific account number in parallel. Thus, once the rules engine finishes evaluating all the event records retrieved by the poller 118 for a specific account number, the event records may be consolidated and sent to the customer.

For event records that are to be consolidated immediately, or after a wait time has expired, the method proceeds to 250 where a single consolidated email formatted based on an email template is generated by the consolidation engine 128. In some embodiments, the email template may be an XML template.

At 252, the send engine 130 sends records to email delivery system 106. In some embodiments the send engine may send the consolidated email template by invoking email API 140 at 254. The consolidated email is then sent to the customer at 256. In some embodiments, the send engine 130 may use Simple Object Access Protocol (SOAP) or hypertext transfer protocol (HTTP) to communicate with email API 140. The email API 140 invokes email delivery server 142 to send the consolidated event record as an email to the customer.

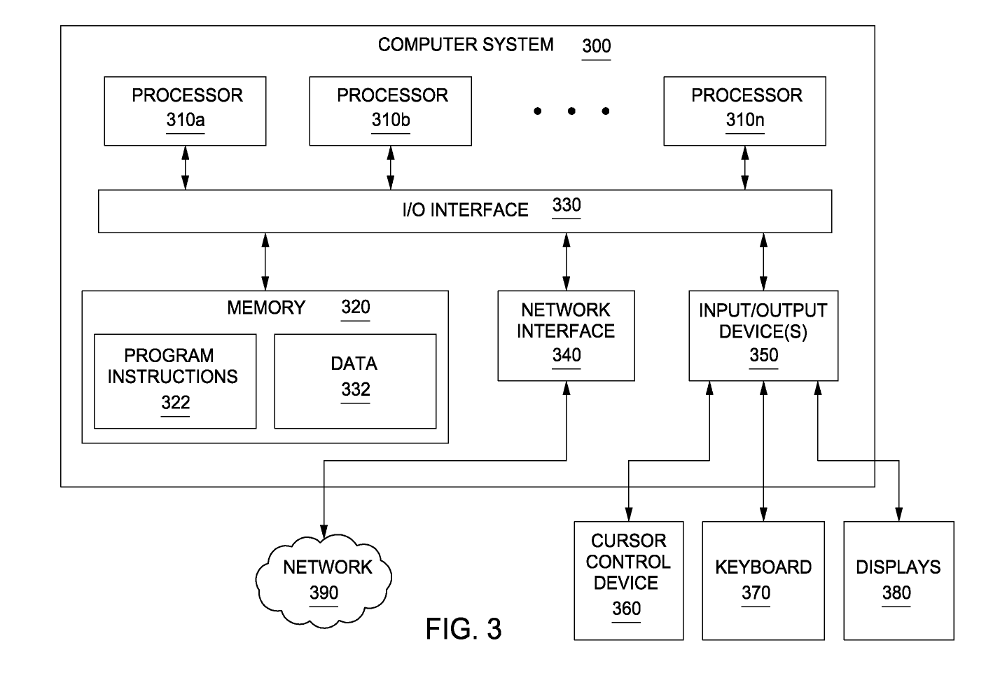

FIG. 3 depicts a computer system 300 that can be utilized in various embodiments of the present invention to implement the computer and/or the display, according to one or more embodiments.

Various embodiments of method and apparatus for routing calls based upon internal network conditions and/or external carrier network information, as described herein, may be executed on one or more computer systems, which may interact with various other devices. One such computer system is computer system 300 illustrated by FIG. 3, which may in various embodiments implement any of the elements or functionality illustrated in FIGS. 1-2. In various embodiments, computer system 300 may be configured to implement methods described above. The computer system 300 may be used to implement any other system, device, element, functionality or method of the above-described embodiments. In the illustrated embodiments, computer system 300 may be configured to implement method 200 as processor-executable executable program instructions 322 (e.g., program instructions executable by processor(s) 310) in various embodiments.

In the illustrated embodiment, computer system 300 includes one or more processors 310a-310n coupled to a system memory 320 via an input/output (I/O) interface 330. Computer system 300 further includes a network interface 340 coupled to I/O interface 330, and one or more input/output devices 350, such as cursor control device 360, keyboard 370, and display(s) 380. In various embodiments, any of the components may be utilized by the system to receive user input described above. In various embodiments, a user interface may be generated and displayed on display 380. In some cases, it is contemplated that embodiments may be implemented using a single instance of computer system 300, while in other embodiments multiple such systems, or multiple nodes making up computer system 300, may be configured to host different portions or instances of various embodiments. For example, in one embodiment some elements may be implemented via one or more nodes of computer system 300 that are distinct from those nodes implementing other elements. In another example, multiple nodes may implement computer system 300 in a distributed manner.

In different embodiments, computer system 300 may be any of various types of devices, including, but not limited to, personal computer systems, mainframe computer systems, handheld computers, workstations, network computers, application servers, storage devices, a peripheral devices such as a switch, modem, router, or in general any type of computing or electronic device.

In various embodiments, computer system 300 may be a uniprocessor system including one processor 310, or a multiprocessor system including several processors 310 (e.g., two, four, eight, or another suitable number). Processors 310 may be any suitable processor capable of executing instructions. For example, in various embodiments processors 310 may be general-purpose or embedded processors implementing any of a variety of instruction set architectures (ISAs). In multiprocessor systems, each of processors 310 may commonly, but not necessarily, implement the same ISA.

System memory 320 may be configured to store program instructions 322 and/or data 332 accessible by processor 310. In various embodiments, system memory 320 may be implemented using any suitable memory technology, such as static random access memory (SRAM), synchronous dynamic RAM (SDRAM), non-volatile/Flash-type memory, or any other type of memory. In the illustrated embodiment, program instructions and data implementing any of the elements of the embodiments described above may be stored within system memory 320. In other embodiments, program instructions and/or data may be received, sent or stored upon different types of computer-accessible media or on similar media separate from system memory 320 or computer system 300.

In one embodiment, I/O interface 330 may be configured to coordinate I/O traffic between processor 310, system memory 320, and any peripheral devices in the device, including network interface 340 or other peripheral interfaces, such as input/output devices 350. In some embodiments, I/O interface 330 may perform any necessary protocol, timing or other data transformations to convert data signals from one component (e.g., system memory 320) into a format suitable for use by another component (e.g., processor 310). In some embodiments, I/O interface 330 may include support for devices attached through various types of peripheral buses, such as a variant of the Peripheral Component Interconnect (PCI) bus standard or the Universal Serial Bus (USB) standard, for example. In some embodiments, the function of I/O interface 330 may be split into two or more separate components, such as a north bridge and a south bridge, for example. Also, in some embodiments some or all of the functionality of I/O interface 330, such as an interface to system memory 320, may be incorporated directly into processor 310.

Network interface 340 may be configured to allow data to be exchanged between computer system 300 and other devices attached to a network (e.g., network 390), such as one or more external systems or between nodes of computer system 300. In various embodiments, network 390 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 340 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 350 may, in some embodiments, include one or more display terminals, keyboards, keypads, touchpads, scanning devices, voice or optical recognition devices, or any other devices suitable for entering or accessing data by one or more computer systems 300. Multiple input/output devices 350 may be present in computer system 300 or may be distributed on various nodes of computer system 300. In some embodiments, similar input/output devices may be separate from computer system 300 and may interact with one or more nodes of computer system 300 through a wired or wireless connection, such as over network interface 340.

In some embodiments, the illustrated computer system may implement any of the methods described above, such as the methods illustrated by the flowchart of FIG. 2. In other embodiments, different elements and data may be included.

Those skilled in the art will appreciate that computer system 300 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 300 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 300 may be transmitted to computer system 300 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for reporting information associated with separate customer event records in a consolidated message, comprising:
associating each of a plurality of event records with at least one rule;
assigning the plurality of event records into at least one group based on an account identifier of a customer associated with each event record; and
for each group of event records, creating at least one consolidated message to be sent to the customer including information associated with at least some of the event records.

2. The method of claim 1, wherein the event records used to create the at least one consolidated message were selected based on the at least one rule associated with each event record.

3. The method of claim 1, further comprising:
for each group of event records, determining a rule action to be applied to each of the event records in the group.

4. The method of claim 3, wherein the at least one consolidated message includes information associated with event records having a common rule action.

5. The method of claim 1, wherein each of the at least one group includes event records associated with a same account identifier.

6. The method of claim 5, wherein the event records included in each group are processed in parallel.

7. The method of claim 6, wherein information associated with the event record is consolidated to be sent to the customer after all records in the group have been processed.

8. The method of claim 6, wherein information associated with the event record is consolidated to be sent to the customer at an end of a predetermined wait time.

9. The method of claim 6, wherein at least one of the event records in the group is removed from an email queue and not sent to the customer.

10. The method of claim 1, wherein the consolidated message is formatted as an XML email template.

11. The method of claim 1, further comprising:
invoking an Application Programming Interface of an email delivery system to send the at least one consolidated message to the customer.

12. The method of claim 1, wherein information from event records that are not associated with a rule are sent directly to the customer without consolidation.

13. The method of claim 1, wherein each event record is generated based on a change made to an account associated with the customer.

14. The method of claim 13, wherein the change to the customer's account that generated the event record includes at least one of adding a telephone line, paying a bill, updating an address of the customer, perform transfers, purchasing additional lines, or changing emergency contact information.

15. A system for reporting information associated with separate customer event records in a consolidated message, comprising:
a tagging engine configured to tag event records with one or more rules and insert the tagged event record into a tagged email queue;
a poller configured to assign the tagged event records in the tagged email queue into at least one group based on an account identifier of a customer associated with each event record; and
a consolidation engine configured to consolidate information associated with the tagged event records into a consolidated email to be sent to the customer.

16. The system of claim 15, further comprising:
a rules engine configured to determine an event record status to assign to each event record based on the one or more rules associated with each event record; and
a send engine configured to send the consolidated email to an email delivery system.

17. The system of claim 16, wherein the consolidated email is in XML format.

18. The system of claim 16, wherein the send engine sends the consolidated email to an email delivery system by invoking an Application Programming Interface of the email delivery system.

19. The system of claim 15, wherein each event record is generated based on a change made to an account associated with the customer.

20. Apparatus for reporting information associated with separate customer event records in a consolidated message, comprising:
a) at least one processor;
b) at least one input device; and
c) at least one storage device storing processor-executable instructions which, when executed by the at least one processor, performs a method including
1) associating each of a plurality of event records with at least one rule;
2) assigning the plurality of event records into at least one group based on an account identifier of a customer associated with each event record; and
3) for each group of event records, creating at least one consolidated message to be sent to the customer including information associated with at least some of the event records.
